(19) United States
(12) Patent Application Publication
(10) Pub. No.: US 2003/0173719 A1
(43) Pub. Date: Sep. 18, 2003

(54) Process for the production of electrical circuits

(76) Inventor: Klaus-Peter Wilczek, Ainring (DE)

Correspondence Address: WENDEROTH, LIND & PONACK, L.L.P., 2033 K STREET N. W., SUITE 800, WASHINGTON, DC, 20006-1021, US

(21) Appl. No.: 10/386,430

(22) Filed: Mar. 13, 2003

(30) Foreign Application Priority Data
Mar. 14, 2002 (EP) 02005801.2

(51) Int. Cl. B28B 1/00

(52) U.S. Cl. 264/616; 264/619

(57) ABSTRACT

A process for the production of electrical circuits which include resistors (1) contacted by noble metals and electrically connected by way of conductor tracks of copper, and possibly dielectrics, wherein at least the contacts (2) of the resistors of noble metal and the adjoining conductor tracks (4) of copper are produced by applying pastes and sintering thereof, and wherein the operation of sintering the conductor tracks of copper is effected at temperatures below 850° C. and below the temperature at which copper forms a eutectic with the noble metal, in a nitrogen atmosphere, and there is an electrically conductive separating layer (5) between noble metal contacts (2) and conductor track (4).

### DESCRIPTION

The invention relates to a process for the production of electrical circuits which include resistors contacted by noble metals and electrically connected by way of conductor tracks of copper, and possibly dielectrics, wherein at least the contacts of the resistors of noble metal and the adjoining conductor tracks of copper are produced by applying pastes and sintering thereof, and wherein the operation of sintering the conductor tracks of copper is effected at temperatures below 850° C. and below the temperature at which copper forms a eutectic with the noble metal, in a nitrogen atmosphere.

A known paste system involves firstly burning in the resistors and dielectrics and the cross-unders comprising a for example AgPt-alloy and resistor terminals at 850° C. in air. Oxygen access is an essential prerequisite for the sintering of noble metal pastes. The copper paste which is required for forming the conductor tracks can be applied only after the operation of burning in the other components, which is effected in air, as thermal hardening thereof must take place in a nitrogen atmosphere.

The air standard pastes have been successfully used for many years, and there is extensive experience in this respect. The individual manufacturers have constantly optimised the noble metal conductor track/dielectrics/resistors systems. Nowadays all properties are satisfied in terms of quality and long-term stability. There is therefore a wish to retain those systems and it is also not possible to replace them with the copper-based technology, for technical reasons. Therefore it was necessary to find a possible way of combining the noble metal technology and the copper technology together in such a way that the properties of the dielectrics and resistors are retained.

For the paste which serves for production of the copper conductor, in itself it would be desirable to implement a burning-in operation in an N₂-atmosphere at 850-980° C. in the presence of 10-20 ppm O₂ in a muffle furnace to achieve optimum adhesion. If however conditions of that kind were to be applied in regard to the known system, that would give rise to the formation in the connecting region of noble metal contacts and copper conductor of a eutectic binary material system which in the case of CuAg has a melting point of about 780° C. That means that, with the furnace temperatures of 800-980° C. which are optimum for the copper conductor, the liquidus temperature of the alloy would be reached at any event. Both materials would melt and would be present in the form of metal balls without adhesion to the substrate. An electrical connection would no longer be secured or interrupted. In order to prevent the formation of a eutectic therefore EP-A-0 790 644 proposes the provision of an electrically conductive separating layer between the copper and the silver.

In contrast to EP-B-0 790 644, the invention is based on a system in which the eutectic temperature of 754° C. is not reached and thus the separating layer between the copper and the silver should be superfluous. For example DuPont, under the name MYDAS, offers such a system in which the burning-in temperature of the copper paste is between 600 and 650° C.

In itself a copper paste which can be burnt in at a temperature below 650° C. appears ideal for resolving the problem of joining the noble metal paste and the copper. More specifically the best connection between the copper and the ceramic carrier materials such as Al₂O₂ or AlN is achieved by so-called oxide bonding: between Cu and O₂ there is a binary eutectic system with a melting point of far above 1000° C. As that bonding process involves intercrystalline formation, an extremely high degree of thermally stable adhesion is produced. Detachment forces of up to 30N/mm² are still withstood even after a continuous temperature loading of for example 1000 hours at 150° C. When complying with all drying and firing or burning requirements—in particular the content of O₂ during the firing operation—such copper tracks, even in layer thicknesses of up to 300 μm, without further refining, can be wetted with solder, welded or bonded with aluminum wire. This therefore ensures the usual joining procedures. The low temperature when burning in the copper paste means that the resistors which are burnt-in, in air, are only marginally altered in the protective gas process, the dielectric structures retain their insulating properties. That means that the standard noble metal system would be preserved complete.

Unexpectedly it has been found that the use of the paste system on which the invention is based is problematical if the electrical circuits produced in accordance therewith are used at temperatures above 100° C. The likely explanation for this is as follows: the join of the noble metal to copper produces a battery effect due to the voltage difference of ˜0.8 volt. Under the effect of temperature and moisture that results in the migration of Ag material into the Cu which changes the crystals of the Cu in such a way that embrittlement of the overlap zone occurs. The adhesive strength of that zone is so weakened after some 100 hours of thermal stressing that conductor track interruptions can occur. In addition a further worsening of electrical conductivity was observed in that zone, which in the case of electronic circuits—particularly when using low-resistance semiconductors—can result in operational failures of the circuits. Due to the loss of adhesive strength in relation to the substrate the overlap zone heats up due to the application of a high current in such a way that it burns through. That has considerable effects on the quality of the electronic circuits, which is unacceptable in relation to uses in the automobile sector, in particular in the region of the engine.

The invention avoids the disadvantages referred to in that the separating layer which was precisely to be avoided by virtue of operating below the eutectic point is introduced again. The invention therefore provides that there is an electrically conductive separating layer between noble metal contacts and conductor track.

The separating layer between copper and silver can already be applied prior to the heat treatment of the copper paste. If a joining material which is to produce the electrical connection and at the same time provide for spatial separation as between the noble metal and the copper is introduced into the gap between the noble metal contact and the copper conductor, the separating layer is fired with the copper conductor upon heating in a nitrogen atmosphere.

The electrically conductive separating layer provided in accordance with the invention can also be implemented after the operation of firing all other parts of the circuit, by a procedure whereby a conductive paste which hardens at low temperatures is applied into the gap between the noble metal contact and the copper conductor. In that respect a conductive adhesive comprising silver distributed in polyimide or epoxy is particularly suitable. Solder paste has proven to be particularly appropriate as the connecting material, which paste is for example applied simultaneously with fitting SMT-components to the conductor track gap. The fusing operation is effected by the reflow process.

By virtue of suitable design measures it is also possible to provide that metallic parts of components are used as a bridging element between the conductor tracks.

Details of the invention will now be described with reference to the drawing in which:

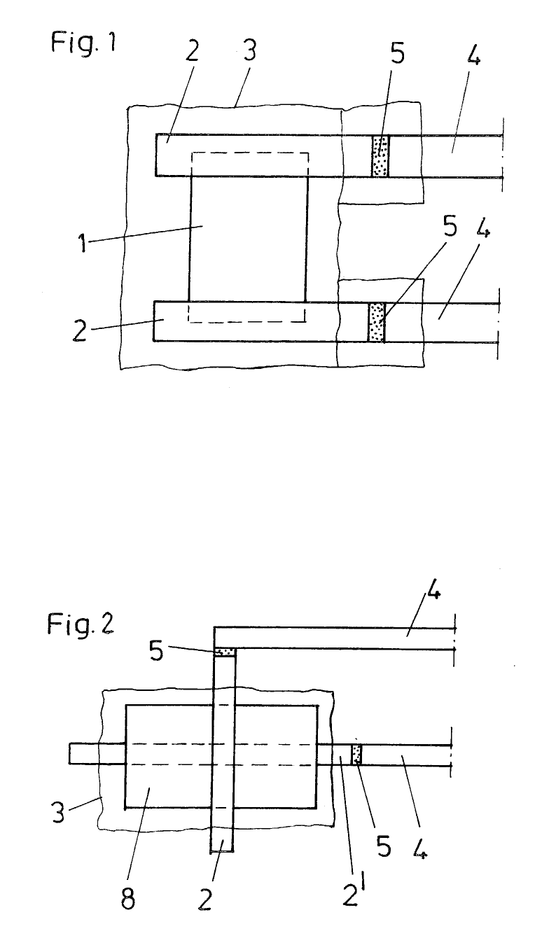

FIG. 1 is a plan view of a first embodiment,

FIG. 2 is a plan view of a conductor crossing which is formed by noble metal tracks and which is contacted with conductor tracks of copper,

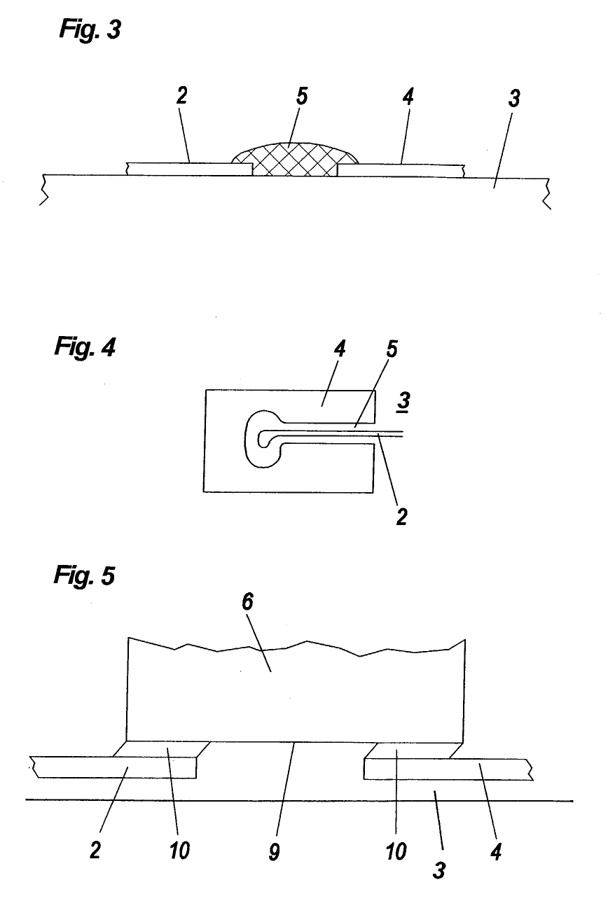

FIG. 3 shows a side view on an enlarged scale of the connecting region between noble metal and copper,

FIG. 4 shows a plan view of a special geometrical configuration of the connecting region, and

FIG. 5 shows a side view of an embodiment in which the separating layer is partly formed by an electronic component.

FIG. 1 shows a portion of a typical electrical circuit of hybrid type. In accordance with that technology a substrate of ceramic is not only printed with connecting tracks for prefabricated components with which the carrier board is fitted, but rather additionally at least resistors are also applied directly to the carrier board.

In the present case a resistor 1 is formed by the application of a paste which is burnt in at 800-950° C. in air. Such a resistor comprising the basic structures Pd/Ag, RuO₂ or Pyrochlor, after sintering, has excellent electrical values such as a low temperature coefficient<50 ppm/K, high electrical load-carrying capacity of up to 100 W/mm², extreme long-term stability in respect of the ohmic values +/−1% after 130,000 hours of normal operation, and very good adjustability of the resistance values with a YAG-laser of up to +/−0.1% tolerance and so forth.

Contacts 2 of noble metal serve for contacting of the resistor 1. Pastes for forming conductor tracks of Ag, PdAg, AgPt, AgPdPt, Au, PdAu and similar combinations for the burning-in operation in air at a burning temperature of 800-950° C. are appropriate. The adhesion of the pastes is afforded in the sintering procedure by additives of gas or oxide-forming agents. In that case typical adhesion strengths of 5-10 N/mm² are achieved. All the specified paste systems are sensitive to thermal ageing and have a tendency to exhibit a reduction in adhesive strength after storage for for example 1000 hours at 150° C. of 20 50%. Gold- and silver-bearing pastes also have the disadvantage of involving a eutectic reaction with the usual soft solder alloys, for example PbSn/PbSnAg. Silver/gold is spontaneously dissolved in tin at soldering temperatures of 220-250° C. In that respect the extreme case involves complete breakdown or decrosslinking of the paste and thus failure of the circuit due to interruptions or a high level of resistance.

The use of such pastes for contacting the resistors and dielectrics is necessary in spite of the suitability, which in itself is better, of copper as a conductor track. More specifically not all and in particular not the best resistors and dielectrics are compatible with copper.

Therefore to form the hybrid circuit firstly the pastes which serve to form the resistor 1 and the contacts 2 are applied one over the other. After the operation of burning in all printed materials jointly at for example 850° C. in air the conductor track 4 is applied by a screen printing process between the contact 1 and 2 and fired at about 600° C. An additional protective layer 3 of glass or polymer can later be applied over the resistors and connecting zones.

The gap between the contact 2 and the conductor track 4 is closed by means of a conductive separating layer 5. Optimum connections are achieved when, to make the connection, the metal components such as connecting legs, component rear sides or edge metallisation portions of components are additionally integrated as a solid bridge.

FIG. 2 shows the use of noble metal contacts 2, 2′ for forming a conductor crossing which is separated by a dielectric separating layer 8. As described with reference to FIG. 1, this also involves firstly applying the regions 2, 2′, 3 and 8 and effecting the burning-in operation in respect thereof, in air. Initially however there is still a gap between the contacts 2, 2′ and the applications of copper pastes for forming the conductor tracks 4, which were effected after the firing operation in air. It is only after the operation of firing the copper paste in a nitrogen atmosphere at high temperature that the gap between the contacts 2, 2′ and the conductor tracks 4 is filled by a conductive separating layer 5. The conductor adhesive serving for that purpose can comprise plastic material such as for example epoxy resin with silver distributed therein. Hardening of the adhesive is effected at ambient temperature or at elevated temperature and then in such a way that the copper does not oxidise at the surface. A temperature of 130° C. should not be exceeded. If a higher hardening temperature should be necessary, for example silver in polyimide, the hardening operation must be effected in N₂. It will be appreciated that instead of the conductor adhesive it is also possible to use a solder join. The hardened conductor layers can then also be covered with a polymer protective layer 3 using a screen printing or dispensing process.

FIG. 3 shows a side view of the separating layer 5 of FIG. 1.

FIG. 4 shows how the gap which is ultimately electrically bridged by the separating layer 5, between noble metal 2 and the conductor 4 consisting of copper, can be so designed that there is a large surface area which involves little susceptibility to trouble, for the transmission of current.

The embodiment shown in FIG. 5 has a large spacing between the noble metal contact 2 and the copper line 4. That is bridged over by an electronic component with a conductive underside 9. The connection between the underside 9 of the component 6 and the sintered pastes 2 and 4 is formed by a soft solder which bonds well with the iron or copper alloys of the underside 9. For example such a soft solder may be based on tin or lead.

It is thus possible with the described processes to implement thick-layer technologies which hitherto could not be combined together, on a common substrate. In that respect the main physical properties of the individual systems are fully retained and supplement each other to afford an optimum technical solution. The good physical properties and the advantageous alloying deposit characteristics of copper conductor tracks permit the use of soldering alloys with a higher melting point (220° C.-250° C.) and the use of all common connecting technologies such as soldering, bonding and welding. New markets and possible uses are therefore seen in particular for use at increased ambient temperatures, for example in automobile engineering. The price advantage of Cu-pastes is also apparent.

A further area of use is permitted by the employment of conductor tracks of copper with selectively higher layer thicknesses, up to about 300 μm. That is of great technical and commercial significance, in the case of uses involving an increased power loss, because of the considerably reduced surface resistance.

1. A process for the production of electrical circuits which include resistors contacted by noble metals and electrically connected by way of conductor tracks of copper, and possibly dielectrics, wherein at least the contacts of the resistors of noble metal and the adjoining conductor tracks of copper are produced by applying pastes and sintering thereof, and wherein the operation of sintering the conductor tracks of copper is effected at temperatures below 850° C. and below the temperature at which copper forms a eutectic with the noble metal, in a nitrogen atmosphere, characterised in that there is an electrically conductive separating layer between noble metal contacts and conductor track.

2. A process as set forth in claim 1 characterised in that the separating layer between the noble metal and the copper is applied in the form of a connecting paste prior to hardening of the conductor track of copper.

3. A process as set forth in claim 1 characterised in that after the sintering operation a gap remains between the contacts of noble metal and the conductors of copper, which gap is then closed by a conductive adhesive, solder or other conductive materials, which forms the separating layer.

4. A process as set forth in claim 2 characterised in that the conductive adhesive substantially comprises silver distributed in polyimide.

5. A process as set forth in claim 1 characterised in that the metal connecting components of structural parts form the separating layer.
